(19) United States
(12) Patent Application Publication
(10) Pub. No.: US 2018/0163894 A1
(43) Pub. Date: Jun. 14, 2018

(54) NEW TYPE OF TURNOVER LIFT FOOT VALVE

(71) Applicant: Hebei Guangde Fluid Control Ltd., Cangzhou City (CN)

(72) Inventors: Zhijun Ji, Cangzhou City (CN); Junqing Lee, Cangzhou City (CN)

(21) Appl. No.: 15/832,202

(22) Filed: Dec. 5, 2017

(30) Foreign Application Priority Data
Dec. 13, 2016 (CN) 201621367804.6

(51) Int. Cl. F16K 31/60; F16K 31/524; F16K 31/56; F16K 1/24

(52) U.S. Cl. CPC F16K 31/602; F16K 31/52408; F16K 15/063; F16K 1/24; F16K 31/566

(57) ABSTRACT

A new type of turnover lift foot valve, including valve body, opening mechanism, valve core, guide mechanism and recovery mechanism; the valve body is set with two guide mechanisms, which are symmetrical and on both sides of valve core. The guide mechanism is provided with main guide rod at one end and with guide groove; there is side guide rod extending into the guide groove; the side guide rod is provided with bearing sleeve. The recovery mechanism includes spring and spring cage, the spring is set between valve core and spring cage; the spring cage is connected to the guide mechanism. Guide groove of the foot valve is in arc shape, so that valve core can deviate from the right above of valve opening and fluid cannot flow into valve body not only from the side of valve opening but also from the right above, which increases flow rate, improves working efficiency and solves the problems of traditional lift foot valve that flow rate is small and unloading is slow due to blockage by valve core.

### CROSS REFERENCE TO RELATED APPLICATION

This application claims priority from Chinese Patent Application No. 201621367804.6, filed Dec. 13, 2016 and entitled “A NEW TYPE OF TURNOVER LIFT FOOT VALVE” the disclosure of which is hereby incorporated entirely herein by reference.

### FIELD OF THE INVENTION

This utility model belongs to technical field of valves, specifically involving a novel turnover lift foot valve.

### BACKGROUND OF THE INVENTION

Guide mechanism of traditional lift foot valve is set on the side of valve core. There are 3 guide mechanisms, which are in contact with valve core to assist valve core in opening and closing. When foot valve is opened and closed, there will be friction between valve core and guide mechanism; long-term use will cause damage to seal ring of foot valve and valve leakage due to wear of valve core and thus affect service life of foot valve; meanwhile, debris generated during valve core friction will fall into foot valve, which thus results in pollution of fluid in foot valve.

At present, guide mechanism of traditional lift valve is generally set perpendicularly to the opening of foot valve, so that valve core is just above the opening of foot valve when foot valve is opened and the fluid can only enter or exit the foot valve on the side, with large flow resistance; thus flow of foot valve is small and the efficiency is low.

### SUMMARY OF THE INVENTION

Purpose of the utility model is to provide a new type of lift foot valve that avoids valve core wear, reduce opening torque and increase service life of foot valve and flow rate so as to solve the problems raised in the above background technology.

In order to realize the above purpose, the utility model provides following technical solutions: a new type of turnover lift foot valve, including valve body, opening mechanism, valve core, guide mechanism and recovery mechanism; the opening mechanism is set to valve body; the valve body is set with two guide mechanisms, which are symmetrical and on both sides of valve core. The guide mechanism is provided with main guide rod at one end and with guide groove; there is side guide rod extending into the guide groove; the side guide rod is provided with bearing sleeve. The recovery mechanism includes spring and spring cage, the spring is set between valve core and spring cage; the spring cage is connected to the guide mechanism.

Preferably, the guide grooves include vertical, oblique and arc-shaped grooves; central axis of vertical groove is perpendicular to the plane of valve opening; vertical and oblique valves are connected with an arc.

Preferably, the opening mechanism includes handle, valve rod and opening components; the handle is connected with one end of valve rod; valve rod is connected with opening component.

Compared with existing technology, beneficial effects of the utility model are as follows: compared with traditional foot valve, number of guide mechanisms of the new type of lift foot valve decreases from three to two, thereby saving material and reduces production cost. Guide mechanism is changed from traditional contact guide to guide groove, thus only side guide rod and bearing sleeve come into rolling contact with guide groove when foot valve is opened and closed, thereby avoiding direct friction between valve core and guide mechanism and preventing seal leakage caused by damage to valve core due to wear and increasing service life of valve core. Guide groove of the foot valve is in arc shape, so that valve core can deviate from the right above of valve opening and fluid can not flow into valve body not only from the side of valve opening but also from the right above, which increases flow rate, improves working efficiency and solves the problems of traditional lift foot valve that flow rate is small and unloading is slow due to blockage by valve core.

### BRIEF DESCRIPTION OF THE FIGURES

FIG. 1 refers to schematic diagram of the new type of lift foot valve

FIG. 2 refers to schematic diagram of the new type of lift foot valve from another perspective view;

FIG. 3 refers to cross-sectional view of the new type of lift foot valve;

FIG. 4 refers to open-state diagram of the new type of lift foot valve.

In figures: 1 valve body, 11 diameter, 2 handle, 3 opening component, 4 valve core, 42 main guide rod, 43 side guide rod, 44 bearing sleeve, 5 spring, 6 spring cage, 7 guide mechanism, 71 guide groove.

### DETAILED DESCRIPTION OF THE INVENTION

The following is clear and complete description of technical solution of the new utility model in combination with figures of new embodiment. Obviously, embodiments described are merely part of embodiments of the utility model instead of all embodiments. Based on utility embodiments of the utility model, all the other embodiments obtained by ordinary technical staff in this field under the premise of without creative efforts are all within the protection scope of the present utility model.

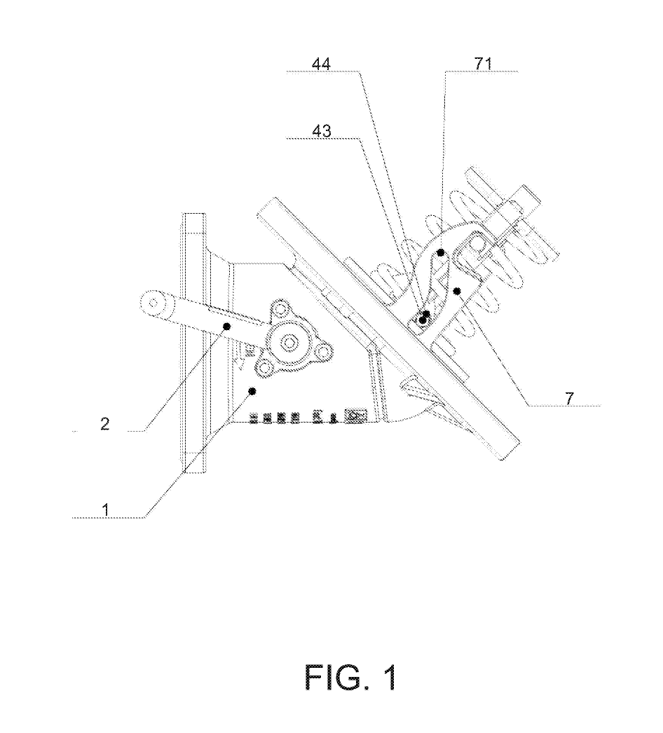

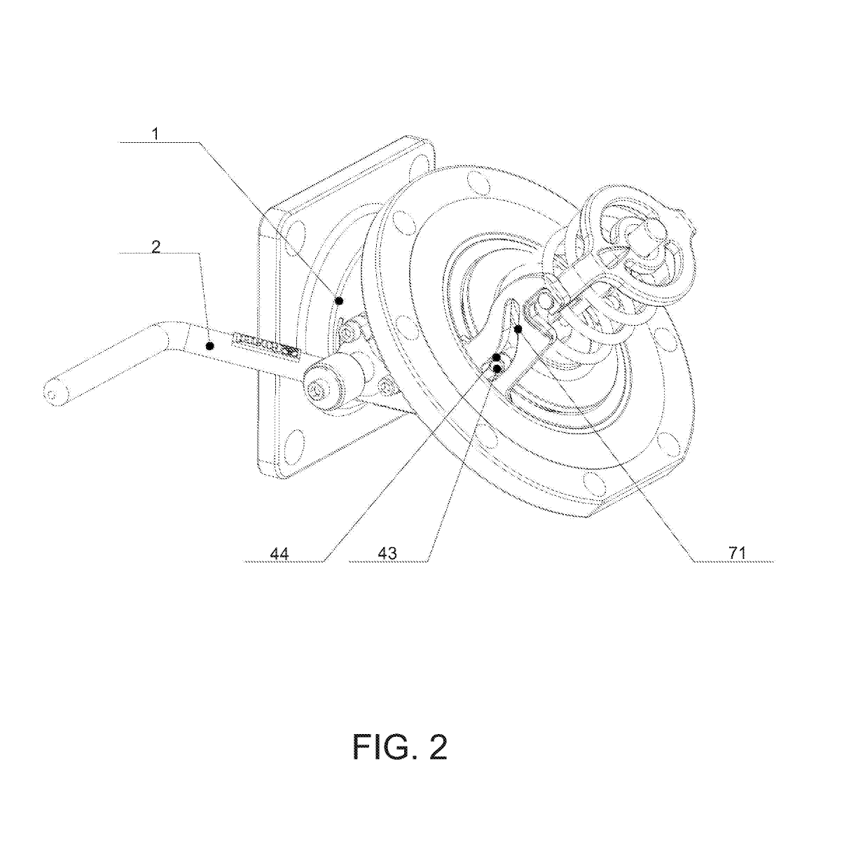

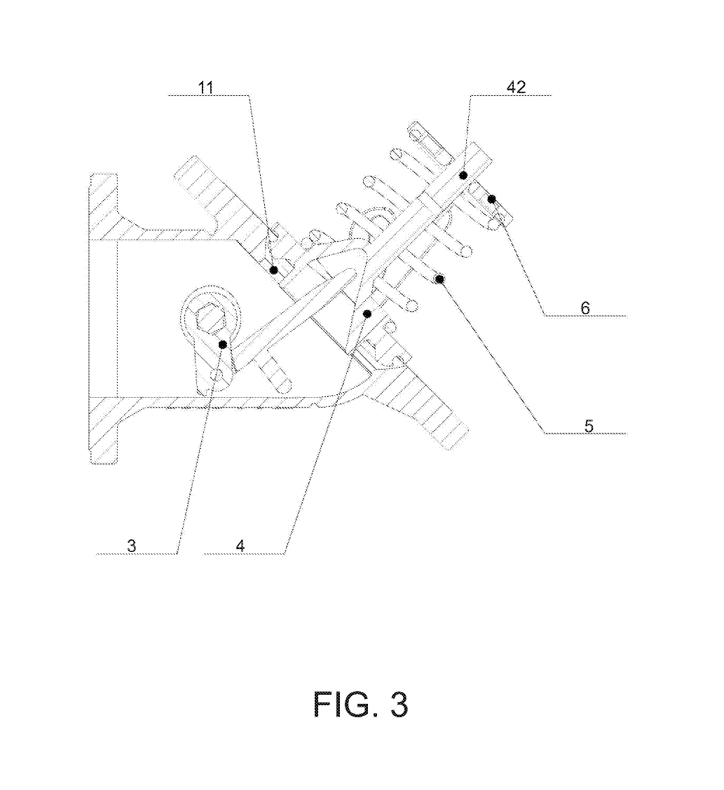

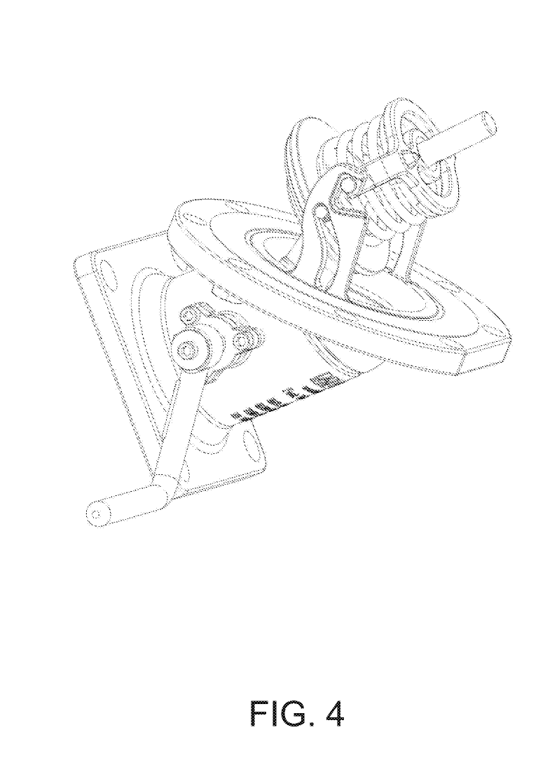

The utility model provides a new type of lift foot valve as shown in FIG. 1-4, including valve 1, handle 2, opening component 3, valve core 4, spring 5, spring cage 6 and guide mechanism 7; one end of the valve body is connected with handle 2; handle 2 is connected with opening component 3 via valve rod; there is side guide 43 and main guide rod 42 on both sides of valve core 4; one side of spring 5 is connected with upper end face of valve core, while the other side is connected with spring cage 6; guide mechanism 7 is provided with guide groove 71.

Valve core 4 achieves the function of lifting and rotating by main guide rod 42 and assists valve core in lifting and rotating in guide groove 71 by side guide rod 43 on both sides and bearing sleeve 44. During installation of spring cage 6, spring cage 6 first presses spring 5, and then rotates to connect with hook in guide mechanism on valve body; this structure not only ensures simple and easy installation but also increases the stability of connection.

Compared with traditional lift foot valve, number of guide mechanisms of this new type of lift foot valve decreases from three to two, thereby saving material and reduces production cost; guide mechanism 7 changes from traditional single-hole guide to guide groove 71 guide, thus only side guide rod 43 comes into rolling contact with bearing sleeve and guide groove 71 when foot valve is opened and closed, thereby avoiding direct friction between valve core 4 and one of three traditional guide mechanisms and preventing seal leakage caused by damage to valve core 4 due to wear and increasing service life of valve core 4 and consequently service life of foot valve; meanwhile, there is very subtle friction between side guide rod 42, bearing sleeve 44 and side guide groove 71, thereby avoiding the drawbacks resulting from traditional foot valve friction and pollution of fluid in valve body 1 and damage to sealing gasket by debris.

In this embodiment, spring 4 described can be replaced by another elastic member, meanwhile spring cage 6 can also be replaced by other fixing member. The present invention does not limit the specific type of elastic member, as long as elastic number described meets the function of recovering to valve core position.

In this embodiment, guide groove 71 described involves vertical groove, oblique groove and arc-shaped groove; central axis of vertical groove is perpendicular to the plane of valve body 1 diameter 11; vertical groove and oblique groove are connected with each other via arc-shaped groove. In this way, valve core 4 may first freely rise perpendicularly to valve body 1 under the guidance of guide groove and then make a rotational movement, then valve core 4 deviates from the right above of diameter of valve body 1, thus increasing the area that fluid flows through valve body and work efficiency and solving the problem that the flow rate becomes small due to large flow resistance of traditional lift foot valve.

For the opening of new type of lift foot valve, first rotate handle 2 on valve body 1; handle 2 drives opening component 3 upward by valve rod; opening component 3 holds out against valve core 4 and jacks up it; side guide rod 43 of valve core 4 and bearing sleeve 44 slide along guide groove 71 of guide mechanism 7 to drive valve core 4 to move along guide slot 71 until valve core reaches predetermined position. Gap forms between valve core 4 and valve body 1 diameter 11; fluid flows into or out of valve body through the gap; for the closing, rotate handle 2 so that valve core 4 starts to move downward under the action of spring 5, meanwhile side guide rod 43 of valve core 4 and bearing sleeve 44 slide backward along guide groove 71 of guide mechanism 7 until valve core 4 is sealed at the valve body 1 diameter 11, thus foot valve is closed.

Finally, it shall be noted that the above description involves merely preferred embodiments of the present utility model and is not limited to the utility model. Although there is detailed description of the present utility model by referring to the foregoing embodiments, technical staff in this field may still modify technical solutions of the foregoing embodiments or carry out equivalent replacement for part of its technical features; all modifications, equivalent replacements, improvements, etc. under the spirit and principal of this utility model shall be included in protection scope of the utility model.

The invention claimed:

1. A new type of turnover lift foot valve, including valve body (1), opening mechanism, valve core (4), guide mechanism (7) and recovery mechanism;
the opening mechanism is set to valve body (1);
the valve body (1) is set with two guide mechanisms (7), which are symmetrical and on both sides of valve core (4);
the guide mechanism (7) is provided with main guide rod (42) at one end and with guide groove (71);
there is side guide rod (43) extending into the guide groove (71);
the side guide rod (43) is provided with bearing sleeve (44);
the recovery mechanism includes spring (5) and spring cage (6), the spring (5) is set between valve core (4) and spring cage (6);
the spring cage (6) is connected to the guide mechanism.

2. A new type of turnover lift foot valve, the guide grooves (71) include vertical, oblique and arc-shaped grooves;
central axis of vertical groove is perpendicular to the plane of valve opening;
vertical and oblique valves are connected with an arc.

3. A new type of turnover lift foot valve, the opening mechanism includes handle (2), valve rod and opening components (3);
the handle (2) is connected with one end of valve rod;
valve rod is connected with opening component (3).
